(19) United States
(12) Patent Application Publication
(10) Pub. No.: US 2006/0175027 A1
(43) Pub. Date: Aug. 10, 2006

(54) Sectional door

(76) Inventor: Guido Langenbach, Buchholz (DE)

Correspondence Address: SCHMEISER, OLSEN & WATTS, 22 CENTURY HILL DRIVE, SUITE 302, LATHAM, NY, 12110, US

(21) Appl. No.: 10/563,019

(22) PCT Filed: Jun. 30, 2004
(86) PCT No.: PCT/EP04/07108

§ 371 Date: Dec. 28, 2005

(30) Foreign Application Priority Data
Jul. 1, 2003 (DE) 103 29 798.7

(51) Int. Cl. E06B 3/12

(52) U.S. Cl. 160/218

(57) ABSTRACT

The invention relates to a sectional door. According to the invention, the sectional door comprises at least one first section and one second section (16, 78), whereby in the closed state, the sections of the sectional door are arranged on top of each other essentially on one plane in order to improve said sectional door and especially in order to provide rapid and safe operation of the sections (16, 78) of said sectional door, and whereby the sections (16, 78) are guided on at least one side edge by means of a section guiding device (12) such that the sections (16, 78) interact with each other without connecting means being arranged therebetween.

The invention relates to a sectional door.

Known from DE 197 26 156 A1 is a high-speed rolling door which is configured as a hanging door. A roller onto which the hanging is wound provides the drive for the door hanging of the door, which acts as a closure element for a wall opening.

Known from DE 26 23 359 B2 is a high-speed rolling door which is termed a closure device. The high-speed rolling door consists of a plurality of sections identified as slats. The sections exhibit L-shaped profiles and are separated by being moved relative one another in a transverse displacement.

Known from DE 196 52 577 A1 is a high-speed rolling door which is likewise termed a closure device. This high-speed rolling door consists of a plurality of sections identified as strip-shaped elements. The sections exhibit flat profiles which only roughly correspond to one another. A tilting mechanism is provided to separate the sections.

DE-GM 19 82 024 makes known a foldable or rollable component. This type of component would encompass folding doors, folding screens and the like which consist of a plurality of sections arranged edgewise. In opening and closing, the sections are moved manually in the horizontal direction whereby a separating mechanism is provided as a transferring means.

Known from DE-PS 01 86 128 is a collapsible folding door which has a guiding device for supporting a hanging. To open and close the folding door, the hanging can be manually moved horizontally. A lever gear (separating mechanism) comprising a servo gear is provided to transfer the physical motion to movement of the hanging.

The task on which the present invention is based is that of providing an improved high-speed rolling door. In particular, a sectional door is to be provided in which sections, configured in particular as panels having profiled front edges, can be maneuvered rapidly and safely. Means are furthermore to be provided to effect same.

This task is solved in accordance with the invention by the features of claims 1 and 12 respectively.

According to the invention, the sectional door comprises at least one first section and one second section, whereby it is provided for the sections of the sectional door to be arranged on top of each other essentially on one plane in the closed state of the sectional door, and whereby it is provided for the sections to be guided on at least one side edge by means of a section guiding device such that the sections interact with one another without connecting means being arranged therebetween. Because the sections are not connected to one another, this eliminates the need for connective elements which could jam or stick during rapid operation. Thus, since the sections are freely arranged on top of or adjacent one another depending upon the opened state of the sectional door and are only resting against each another, installation and maintenance of the sectional door is also facilitated since the sections can be readily manipulated without first needing to disengage any connections between them.

In the closed state of the sectional door, two sections lying atop one another will preferably have matching profiles at their opposing contact edges, in particular deep tongue-groove profiles, resulting in the individual sections bracing against each other. This high degree of impermeability to the door in its closed state furthermore prevents heat, noise and dirt from penetrating.

A tilting mechanism or external manipulators can be used to separate the profiles of the sections. Preferably, however, a separating device is provided on at least one lowest section which spreads the sections apart in their planar extension such that the profiles disengage. This results in a compact sectional door which allows easy maintenance since after replacing a defective section, the sectional door is quickly returned to functional state. Should more than two sections be provided, all sections except for the uppermost section should be provided with separating devices.

A particularly simple design, and one thus not prone to malfunction, is given when, in accordance with a preferred embodiment, the separating device(s) have a lift lever guided in a slot. The lift lever should preferably be configured as a track for a lift roller.

A particularly economical drive can be achieved when, in accordance with a preferred embodiment, only the lowest section is driven when the sections are moved, whereby this will then drive the at least one section positioned above.

A preferred embodiment in which the sections are arranged edgewise adjacent one another in the opened state of the sectional door yields a compact sectional door, whereby to move these sections over these lengths, the sections have roller or slider tracks, e.g. section counter bearing rails along which the sections roll or slide. Because the sections always remain on edge, deformations and the disadvantages associated therewith are avoided.

An offset roller which engages with an offset rail is preferably provided for the lateral offsetting of the sections when opening the sectional door. Such a mechanical means, its effect ensuing from the raising of the lowest section, is particularly low-maintenance and not prone to malfunctions.

A more reliable operation of the sectional door is achieved when, in accordance with a preferred embodiment, the section guiding device has at least one guide rail arranged in the area of a door opening in essentially vertical extension which merges with an essentially horizontally-extending carrier rail in a transition radius in a section receiving area.

In order to achieve a particularly reliable operation of the sectional door, it is furthermore preferred to provide a counter bearing device in the section receiving area (expansion area) which prevents the sections from tilting in the section receiving area. It is further conducive to the cited purpose to provide a left and a right section guiding device which are configured to be essentially symmetrical to one another and interact with correspondingly symmetrically-configured mechanisms on the sections.

Economical manufacture yields from providing a section guiding profile for a sectional door having a guide rail and an offset rail. Such a section guiding profile moreover aids in tolerance compliance.

Preferably, the section guiding profile is of C-shaped configuration, whereby the guide rail and the offset rail are configured at opposite sides on the inner side legs with reciprocal offset relative the connecting leg. This thus allows for the disposing of only a minimum of guiding members on the sections. Economical manufacture is thus facilitated by an extruded or continuous casting profile configuration.

Other advantageous embodiments and further developments of the invention will become apparent from the subclaims as well as from the description in conjunction with the drawings, which show:

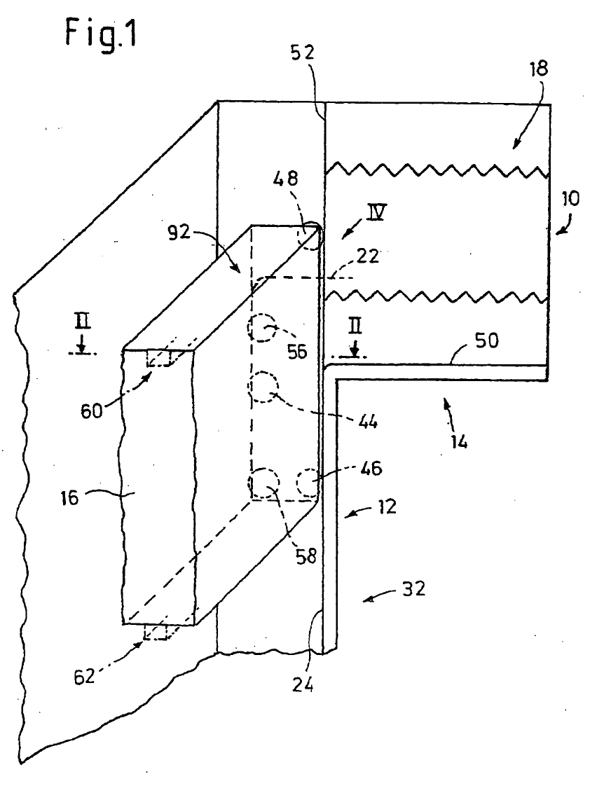

FIG. 1 a schematic perspective representation showing an upper corner area of a sectional door having only one section in accordance with a first embodiment of the invention,

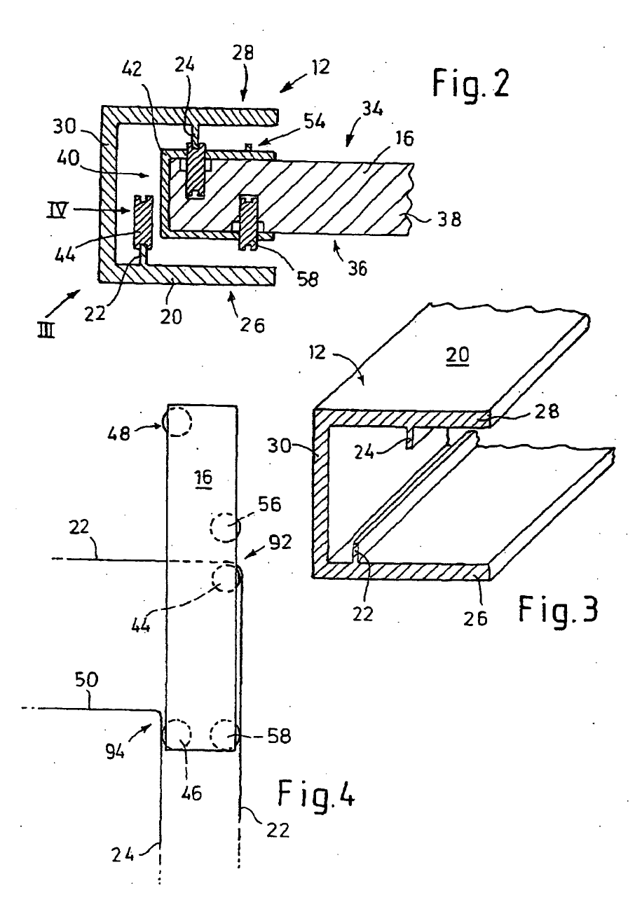

FIG. 2 a sectional view through the sectional door along the II-II line from FIG. 1,

FIG. 3 a perspective depiction of the section guiding profile of the sectional door,

FIG. 4 a schematic view of a side front edge of a section, whereby the offset rail as well as the carrier and guide rail are also depicted,

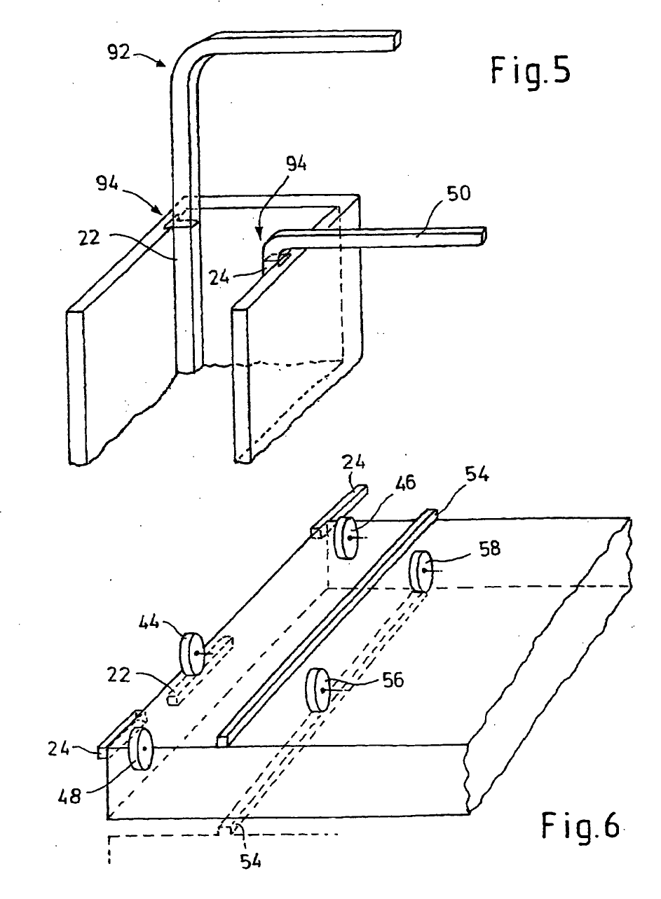

FIG. 5 a schematic perspective representation of a section guiding profile of the sectional door at its upper corner area,

FIG. 6 a schematic perspective representation of a section of the sectional door, whereby the associated rail sections are also depicted so as to better illustrate the arrangement of the individual rollers,

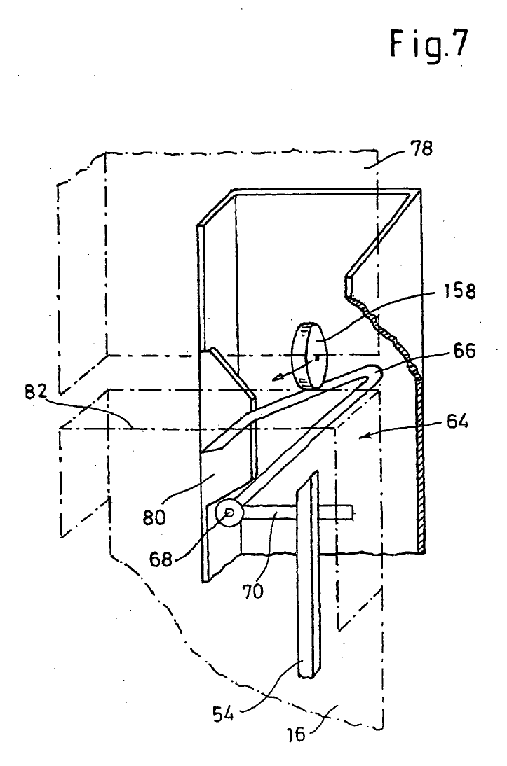

FIG. 7 a schematic perspective representation of two sections of a sectional door connected to the section guide, whereby the lower section exhibits a separating device which interacts with a lift roller on the section lying above it,

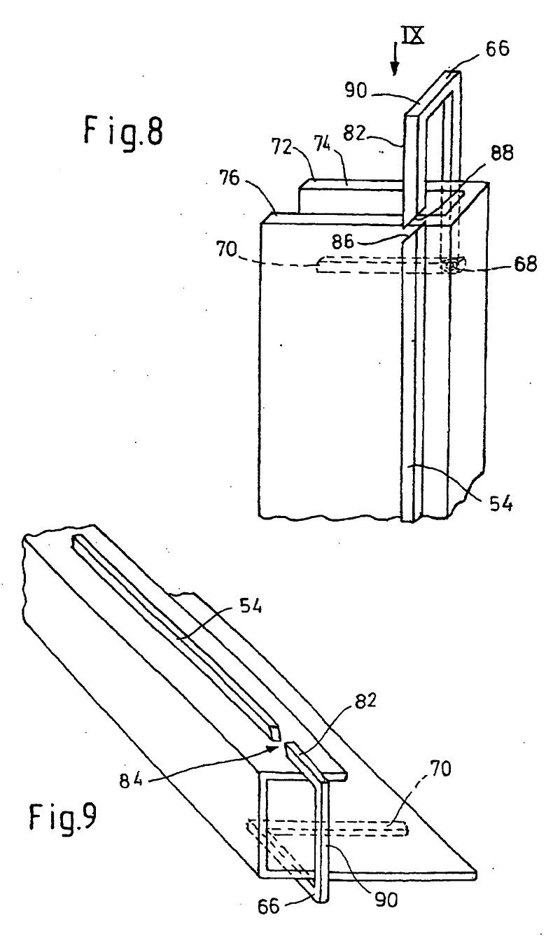

FIG. 8 a schematic perspective representation of the separating device from FIG. 7,

FIG. 9 a schematic perspective representation of the separating device from FIG. 8 as per the IX arrow in FIG. 8,

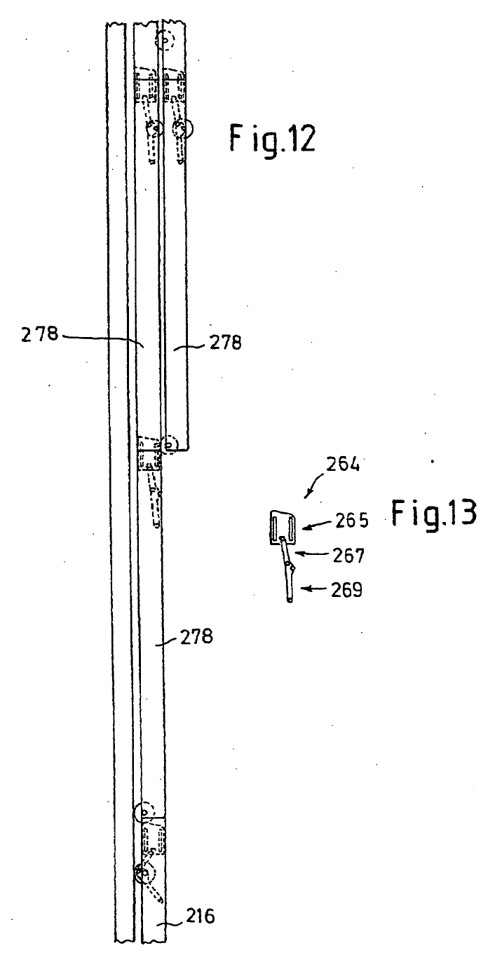

FIGS. 10 to 13 show a second embodiment of a sectional door in accordance with the invention, and

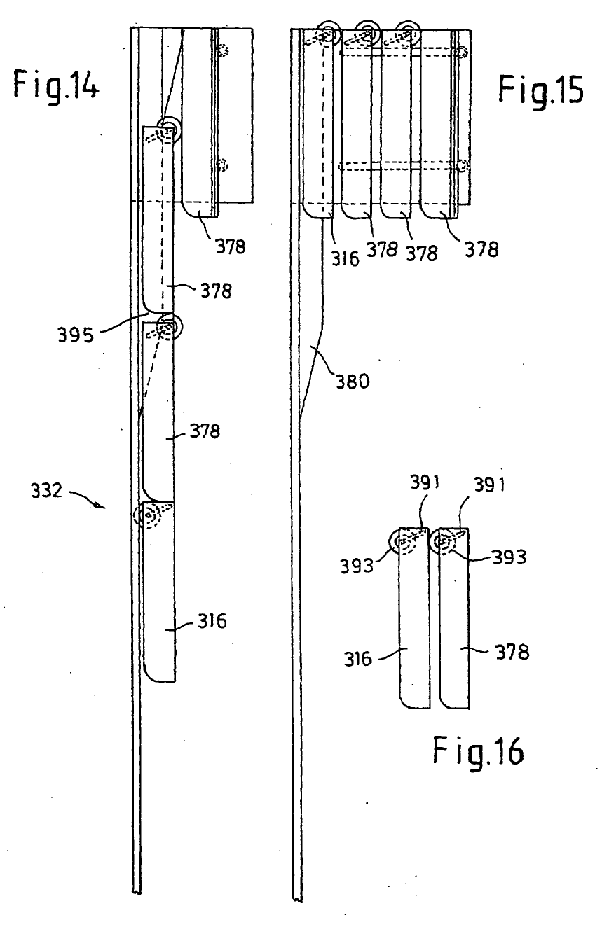

FIGS. 14 to 16 show a third embodiment of a sectional door in accordance with the invention.

The upper corner area shown in FIG. 1 of a sectional door 10 in accordance with the invention shows a section guiding device 12 as well as an expansion area 14 which serves to receive raised sections (section receiving area). As an example of a section, FIG. 1 shows a first, lowest section 16 which positions against a counter bearing device 18 disposed in expansion area 14 in the raised state.

Section guiding device 12 exhibits an essentially C-shaped section guiding profile 20 configured as a continuous casting profile of aluminum and on which an offset rail 22 as well as a guide rail 24 are configured. It can be seen from FIG. 2 that offset rail 22 and guide rail 24 are configured on a first side leg 26 and a second side leg 28 respectively, whereby guide rail 24 is offset from offset rail 22 relative base leg 30.

Offset rail 22 and guide rail 24 serve to guide section 16 on opposites sides 34, 36 of said section 16 in the area of a door opening 32, whereby each section 16 is essentially of one section leaf 38 as well as disposed with a roller carrier device 42 at each of the lateral front sides 40. Each roller carrier device 42 supports an offset roller 44, which interacts with offset rail 22, arranged approximately centrically to the height of section 16 on roller carrier device 42 in the transverse lateral extension of section 16. Roller carrier device 42 furthermore supports a lower guide roller 46 as well as an upper guide roller 48 which interacts with guide rail 42 in the area of door opening 32.

Since guide rail 24 on which sections 16 are supported by their lower guide roller 46 merge in a radius with carrier rail 50 in expansion area 14, the upper guide roller 48 would be unanchored if it was not supported by one of the counter bearing rails 52 configured on counter bearing device 18. Since, however, said counter bearing rails retract with counter bearing device 18 upon the advancing of other sections and lower section 16 is thus inaccessible, section counter bearing rails 54 are configured on sections 16 which interact with the support rollers 56, 58 configured on roller carrier device 42. Section counter bearing rails 54 and support rollers 56, 58 are in an offset third plane relative offset roller 44 and guide rollers 46, 48. Rollers 44, 46, 48, 56, 58 and rails 22, 24, 52, 54 are arranged such that each section 16 is always guided at least at three points on each side of the sectional door.

Since section leaves 38 exhibit profiles 60, 62 matched to one another at their upper and lower edge (depicted in FIG. 1 by a dashed line), a separating device 64 is provided (FIG. 7 to FIG. 9) which spreads sections 16, 78, only depicted in outline in FIG. 7, apart from one another. Separating device 64 comprises a lift lever 66, its swivel axis 68 guided in slot 70 which is configured in profile 72 of roller carrier device 42.

FIGS. 7 to 9 show that in a mounted section 16, slot 70 extends horizontally in leg 74 of profile 72 which positions against side 36 of section leaf 38. Said leg 74 is positioned opposite leg 76 on which section counter bearing rail 54 is arranged.

When section 16 is raised and a section 78 situated above same thus reaches the expansion area, swivel axis 68 is shifted in the slot by guide plate 80 so that lift lever 66 is displaced from the low position shown in FIG. 7 into the extended position shown in FIGS. 8 and 9. In said extended position, a guide section 82 of lift lever 66 is positioned such that said guide section 82 continues beyond a minimum gap 84 as section counter bearing rail 54.

Mitres 86, 88 on section counter bearing rail 54, guide section 82 respectively, facilitate the adjustment and ensure that a roller 58, 56 moving over guide section 82 to section counter bearing rail 54 reliably reaches said section counter bearing rail 54.

When separating sections 16, 78, lift lever 66 of section 78 positioned above raises over lift roller 158 of section 78 positioned above, whereby to be noted here in this regard is that all sections with the exception of the lowest section are configured correspondingly. Upon this lifting, lift roller 158, which is the equivalent of support roller 58, positions on a lift section 90 of lift lever 66, which extends essentially transverse to guide section 82 of lift lever 66 at the top of each section. It follows from the above that lift roller 185 moves with respect to section 16 below from its upper edge to its side, which is in consequence of the lateral offsetting in the supporting area.

Offset rail 22, which merges with a horizontal extension from its vertical extension at a radius 92, is provided to effect the lateral offsetting of the sections. Thus, a section 16 to be raised is forced into a lateral displacement by its offset roller 44, as is evident from FIG. 1. It should be mentioned at this point that roller 56 is thereby not obstructive since same is positioned on an plane offset with respect to offset rail 22.

In order to provide a smooth transition, it is advantageous to configure offset rail 22 in the area of radius 99 as an aluminum casting extending over a dovetail profile 49 which can be easily countersunk into section guiding profile 20.

The transition of guide rail 24 into carrier rail 50 should also be configured in similar fashion, whereby it is to be noted that radius 92 of offset rail 22 is larger than radius 94 in the transition area from guide rail 24 into carrier rail 50.

The second embodiment of a sectional door according to the invention shown in FIGS. 10 to 13 exhibits a lowest section 216 as well as additional sections 278. One separating device 264 used in this embodiment comprises a thrust member 265 which is raised over a first and a second hinged lever 267, 269 in relation to the associated section 216, 278 when an offset roller 244 runs over the associated guide plate 280.

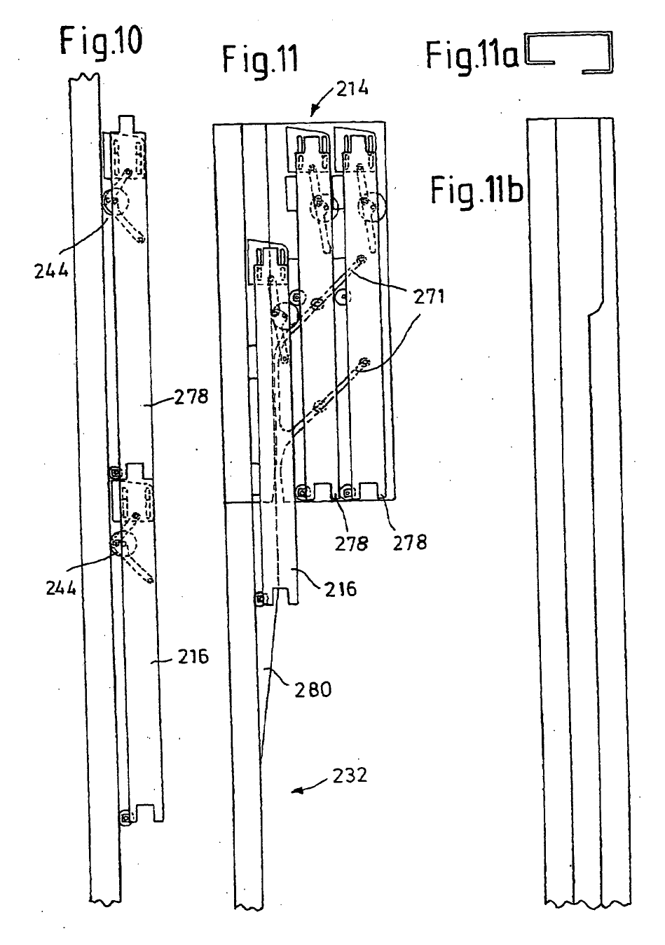

FIG. 11 shows how sections 278 can be supported in a parallel arrangement in a section receiving area 214 above door opening 232, whereby transversely extending receiving rails 271 support section 287 in interaction with the lowest section 216. As is the case in the first embodiment, only the lowest section is driven in this embodiment, whereby the drive for the lowest section can ensue via a cable hoist or even by means of a belt or a separating mechanism operative upon opening and closing. When closing the door, sections 287 follow the lowest section 216 or 16 respectively due to the force of gravity, in like manner as sections 78 in the first embodiment. FIGS. 11a and 11b show a sectional view, one view respectively, of a lateral section guiding profile. It is pointed out that thrust member 265 raises the above-lying section 278 over a lift roller which enables a rolling off from the thrust member.

The third embodiment of an inventive sectional door shown in FIGS. 14 to 16 is an interim solution between the inventive sectional door according to the first embodiment and the inventive sectional door according to the second embodiment. Similar to the first embodiment, slots 291 are provided to support a lift roller 293 with a displaceable axis, wherein a curved profile 395 is now configured at the section 378 above in place of a lift roller 291. In this embodiment as well, sections 316, 378 are received in a section receiving area 314 above a door opening 332.

The present invention has been described based on the use of guide rails. In place of such guide rails, however, the scope of the invention would also allow for providing guideways for achieving the same effects.

1. Sectional door comprising at least one first and one second section, whereby the sections are arranged on top of each other essentially on one plane in the closed state of the sectional door and whereby the sections are guided on at least one side edge by means of a section guiding device,
characterized in that
the sections interact with each other without connecting means being arranged therebetween.

2. Sectional door in accordance with claim 1, characterized in that in the closed state of the sectional door, two sections lying atop one another exhibit matching profiles, in particular deep tongue-groove profiles, at their facing contact edges.

3. Sectional door in accordance with claim 1, characterized in that a separating device is provided on at least one lowest section which spreads the sections apart from one another in their planar extension such that said profiles disengage.

4. Sectional door in accordance with claim 3, characterized in that said separating device comprises a lift lever guided in a slot.

5. Sectional door in accordance with claim 4, characterized in that said lift lever is configured as a track for a lift roller.

6. Sectional door according to claim 1, characterized in that only the lowest section is driven when the sections are moved, whereby this will then drive the at least one section positioned thereabove.

7. Sectional door according to claim 1, characterized in that sections are arranged edgewise adjacent one another in the opened state of the sectional door, whereby to move these sections over these lengths, the sections have roller or slider tracks, in particular section counter bearing rails, over which the sections roll or slide.

8. Sectional door according to claim 1, characterized in that an offset roller is provided which engages at least by sections with an offset rail for the lateral offsetting of the sections when opening said sectional door.

9. Sectional door according to claim 1, characterized in that the section guiding device has at least one guide rail arranged in the area of a door opening in essentially vertical extension which merges with an essentially horizontally-extending carrier rail in a transition radius in a section receiving area.

10. Sectional door according to claim 1, characterized in that a counter bearing device is provided in the section receiving area which prevents the sections from tilting in the section receiving area.

11. Sectional door according to claim 1, characterized in that a left and a right section guiding device are configured to be essentially symmetrical and to interact with correspondingly symmetrically-configured mechanisms on the sections.

12. Section guiding profile for a sectional door comprising a guide rail and an offset rail.

13. Section guiding profile in accordance with claim 12, characterized in that said section guiding profile is of C-shaped configuration, whereby the guide rail and the offset rail are configured at opposite sides on the inner side legs with reciprocal offset relative the connecting leg.

14. Section guiding profile in accordance with claim 12, characterized in that same is of extruded or continuous casting profile configuration.

15. Sectional door according to claim 1, characterized by a section guiding profile for a sectional door comprising a guide rail and an offset rail.
